(19) United States
(12) Patent Application Publication
(10) Pub. No.: US 2013/0230826 A1
(43) Pub. Date: Sep. 5, 2013

(54) DENTAL PROSTHETIC APPLIANCE

(71) Applicant: Yeong Man OH, Paju-si (KR)

(72) Inventor: Yeong Man OH, Paju-si (KR)

(21) Appl. No.: 13/778,664

(22) Filed: Feb. 27, 2013

(30) Foreign Application Priority Data
Mar. 5, 2012 (KR) 10-2012-0022468

(51) Int. Cl. A61C 13/265

(52) U.S. Cl. CPC A61C 13/2653
USPC 433/172

(57) ABSTRACT

A dental prosthetic appliance is provided to recover the functions of damaged teeth to stably fix a denture made of a metallic material or a ceramic material at its neighboring abutment teeth for the purpose of recovering the function of damaged teeth. The fixing member comprises an engaging groove arranged in an upward direction with respect to a tooth root is formed at an engaging surface contacting with the abutment tooth of the denture, and an engaging groove engaged to the denture for an engaging surface contacting with the abutment teeth, respectively, not to expose to the sides of a tongue or lips. A support is attached to the surfaces of the cut-away portions formed with certain depth by cutting off the engaging surfaces of the abutment teeth each contacting with the denture and the rim portion of the upper surface of each of the abutment teeth.

### CROSS REFERENCES

This application claims the benefit of Korean Patent Application No. 10-2012-0022468, filed 5 Mar. 2012, which is hereby incorporated by reference in its entirety into this application.

### BACKGROUND OF THE INVENTION

The present invention relates to a dental prosthetic appliance, and in particular to a dental prosthetic appliance which makes it possible to help recover the functions of damaged teeth in such a way to stably fix a denture made of a metallic material or a ceramic material at its neighboring abutment teeth, respectively, for the purpose of recovering the function of damaged teeth.

Generally speaking, a tooth structure of a normal person consists of 16 upper jaw teeth and 16 lower jaw teeth, 32 in total. Deciduous teeth naturally are substituted with permanent teeth as people grow up, so people chew with grown up teeth for their lives.

If the teeth get rotten or damaged due to a certain accident after the grown teeth are made, the people with such problems come to suffer from inaccurate pronunciations and hard chewing when eating foods. The people may feel depressed due to the damaged teeth, which may lead to a hard social activity.

When the teeth are damaged, a denture generally is used in an attempt to recover the functions of damaged teeth with the aid of a prosthetic appliance.

The kinds of dentures consist of an ordinary prosthetic appliance which serves to cover a tooth dysfunctioned by over decays or endodontic treatments for thereby recovering the functions of damaged teeth, an esthetic prosthetic appliance which serves to improve the discoloration, abnormal shapes and spaces between teeth generally in front teeth, and an implant prosthetic appliance which has features in that an artificial tooth root is planted in a portion where a tooth is damage, and a denture is thread-connected at the artificial tooth root.

The ordinary prosthetic appliance among the above mentioned lists of prosthetic appliances has features in that so as to fix a denture at a portion of the damaged tooth, a cap is prepared for covering the tops of neighboring healthy teeth, and the cap is covered on the healthy tooth for thereby fixing the denture, which is called a crown bridge.

The ordinary prosthetic appliance takes short operation time and is known cheap and easy; however the dentins should be inevitably ground off as much as the thickness of the cap since the denture should be linked to the neighboring teeth. When the dentins are cut off, a dental pulp may be exposed to the outside, which may bring an endodontic treatment. The dental pulp may change after operations, and if air or an impurity is inputted into between the cap and the tops of the teeth, the healthy teeth may easily change to rotten teeth.

The implant prosthetic operation has advantages in that the functions of the damaged teeth can be overcome without damaging the dentures and the neighboring healthy teeth in such a way that an implant prosthetic appliance is fixed by engaging the denture with a screw after a metallic artificial tooth root is installed at an upper jaw or a lower jaw in which teeth are arranged; however the implant prosthetic operation takes long time (8-12 months), and it costs a lot. When a metallic artificial tooth root is planted, lots of machine noises occur, so a patient may suffer increased psychological pains.

### SUMMARY OF THE INVENTION

Accordingly, the present invention is made to improve the above described problems, and it is an object of the present invention to provide a dental prosthetic appliance which has features in that an operation can be done faster along with an easier operation and a low operation cost when recovering the functions of damaged teeth and it is possible to minimize a patient's psychological repulsion to operations in terms of the operations of dentures.

To achieve the above object, there is provided a dental prosthetic appliance comprising a fixing member which has an engaging groove arranged at an engaging surface contacting with each of an abutment tooth of a denture in an upward direction with respect to a tooth root and an engaging groove engaged to the denture for an engaging surface contacting with each of the abutment teeth not to expose to the sides of a tongue or lips, and a support member which has a support attached to the surface of each of the cut-away portions formed by cutting off by certain thicknesses the engaging surface contacting with the denture and the rim portion of the upper surface and a support portion engaged to the engaging groove of the fixing member.

It is preferred that the fixing member engaged to the denture and the support member attached to each of the abutment teeth are formed at the engaging surfaces contacting with the denture and the abutment teeth for them not to be visually seen when viewing them from the sides of a tongue or lips.

In addition, there are further provided a pin hole at each of the abutment teeth when attaching the support member to each of the abutment teeth, and a fixing pin formed at an inner surface and fixedly inserted in the pin hole.

The dental prosthetic appliance according to the present invention has features in that the functions of damaged teeth can be faster recovered with the aid of the simplified operations when operating the dentures at the portions of the damaged teeth in an attempt to recover the functions of the damaged teeth, and such recovery can be performed in an easier way, and the operation does not cost a lot, and it is possible to minimize the patient's psychological repulsions to the operations.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating an example of the operations of a dental prosthetic appliance according to the present invention;

FIG. 2 is a disassembled perspective view illustrating a dental prosthetic appliance according to the present invention;

FIG. 3A is a cross sectional view illustrating a state before a dental prosthetic appliance is planted according to the present invention;

FIG. 3B is a cross sectional view illustrating a state after a dental prosthetic appliance is planted according to the present invention;

FIG. 4 is a plane cross sectional view illustrating a state after a dental prosthetic appliance is planted according to the present invention; and

FIG. 5 is a perspective view illustrating a state that the operation of a dental prosthetic appliance is finished according to the present invention.

### DETAILED DESCRIPTION OF THE INVENTION

The preferred embodiments of a dental prosthetic appliance according to the present invention will be described with reference to the accompanying drawings.

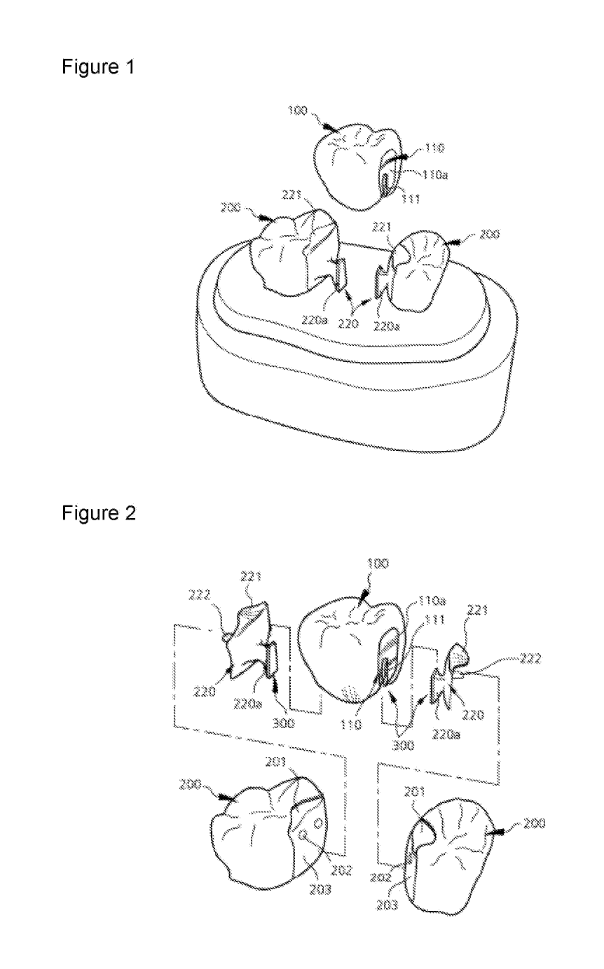

As shown in FIGS. 1 to 3B, the dental prosthetic appliance according to a preferred embodiment of the present invention comprises a denture 100 installed at a portion of a damaged tooth, and a fixing part 300 for connecting and fixing the denture 100 at its neighboring abutment teeth, respectively.

The denture 100 is artificially made in the same shape and size as the damaged tooth (not shown) and may be made of a metallic material or a ceramic material.

Here, the abutment teeth 200 each mean a healthy tooth which is near the damaged tooth (not shown).

The fixing part 300 serves to fix the denture 100 engaged at a portion of the damaged tooth at the abutment teeth 200, respectively. In a preferred embodiment of the present invention, the fixing part 300 comprises a denture 100 to which a fixing member 110 having an engaging groove is engaged for it not to expose to the sides of a tongue or lips at the engaging surfaces coming contact with the abutment teeth 200, a support 221 which is attached to an engaging surface (not shown) coming contact with the denture 100 and is attached at a cut-away portion which is formed by cutting off a rim portion of the upper surface, and a support member 220 with a support portion 220a engaged to the engaging groove 111 of the fixing member 110.

The fixing member 110 comprises a concave engaging part 110a with a certain curvature corresponding to the shape of each of the abutment teeth 200 at the engaging surface at the side of the denture coming into contact with each of the abutment teeth 200. The engaging groove 111 to which the support portion 220a is engaged is provided in a vertical direction at the engaging part 110.

The support member 220 is attached to an engaging surface (not shown) of each of the abutment teeth 220 coming into contact with the denture 200, and the support member 220 comprises a support portion 220a inserted in the engaging groove 111 formed at the denture 100 and a support 221 attached to the rim portion of the upper surface of each of the abutment teeth.

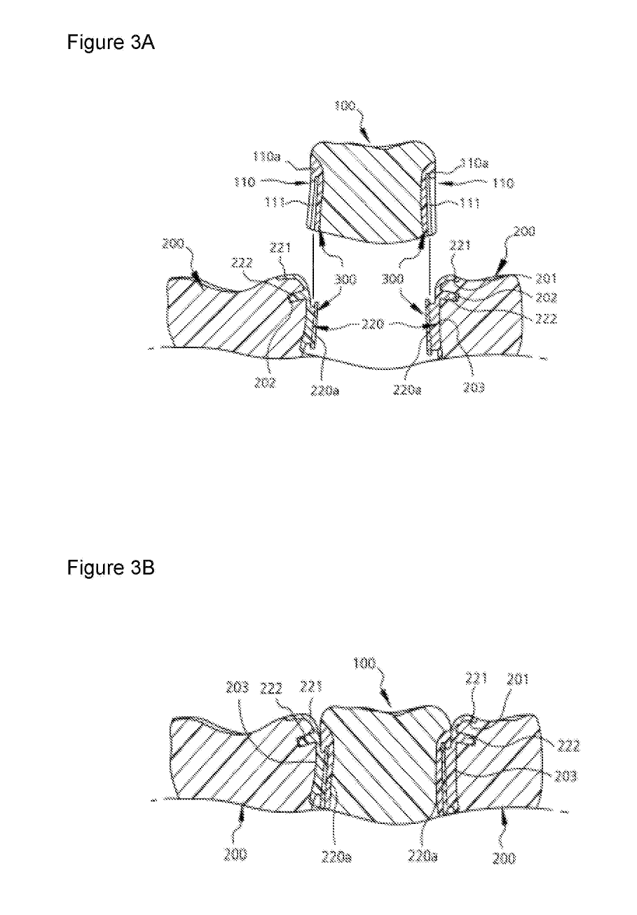

As shown in FIGS. 2 to 3B, the support member 220 further comprises a pair of fixing pins 222 which are fixedly inserted in pin holes 202 which are obliquely and downwardly formed with certain depths at the opposing surfaces facing the abutment teeth 200, respectively.

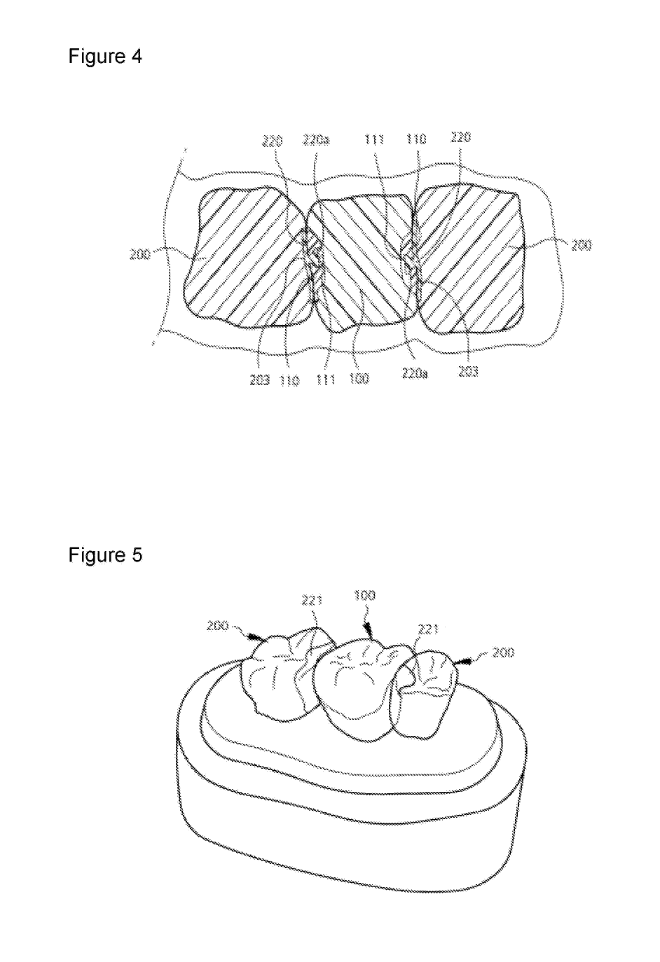

As shown in FIG. 4, the support member 220 is attached only to the engaging surface of each of the abutment teeth 200 coming into contact with the engaging part 110a of the denture 100, so the support member 220 is not seen when viewing it from the sides of the tongue and the lips.

In addition, the thickness of the support member 220 is decided depending on the depth of the cut-away portions. When the support member 220 is attached to a cut-away portion 203 of the engaging surface of each of the abutment teeth 200 and a cut-away portion 201 of the upper surface, it is preferred that any steps are not formed between the rim surface of the support member and the non cut-away boundary surface of each of the abutment teeth.

The abutment teeth 200 each comprises cut-away portions 203 and 201 formed by cutting off by certain thicknesses parts of the engaging surface coming into contact with the denture 100 and the rim portion of the supper surface for the sake of attachments of the support member 220. It is preferred that the cut-away portion 203 of the engaging surface of each of the abutment teeth 200 and the cut-away portion 201 of the rim portion of the upper surface of each of the abutment teeth are cut off by 1-2 mm from the surface of each of the abutment teeth 200.

It is preferred that the depth of the pin hole 202 formed at the opposed surface facing the abutment teeth 200, respectively, is 1.5-2 mm for any neuron not to expose to the outside.

The support portion 220a is inserted in the engaging groove 111 for the purpose of fixing the denture 100. The support portion 220a is arranged in the same direction as the arrangement of the engaging groove 111, the cross section of which is formed in a T-shape. The T-shaped support portion 220a is formed with its width gradually increasing toward the direction of the tooth root. In other words, it is shaped like a trapezoid shape with the upper side being wider and the lower side being narrower.

The trapezoid shaped support portion 220a has advantages in that it can help more engage tightly the denture 100 when the support portion 220a is inserted in the engaging groove 111 of the denture 100 for the purpose of engaging the denture 100 without any spaces, and a smooth engagement can be achieved

The operations of the dental prosthetic appliance according to the present invention will be described with reference to the accompanying drawings.

In order to accurately engage the denture 100 at a portion of the damaged tooth, the rim portions of the upper surfaces of each of the abutment teeth neighboring with the engaging surface of each of the abutment teeth 200 near the denture 100 is cut away with a depth of 1-2 mm, for thereby forming cut-away portions 203 and 201.

At this time, when forming the cut-away portions at the rim portions of the upper surfaces of each of the abutment teeth 200, it is possible to for a worker to cut away controlling the size and the portion of the cut-away portion 201 in consideration of the size and state of each of the abutment teeth 200, and a pair of pin holes 202 are obliquely and downwardly formed at the opposed surfaces facing the abutment teeth 200, respectively. It is preferred that the pin holes 202 are formed with the angles of 45° with respect to the vertical axis of each of the abutment teeth.

It may be considered that the pin holes 202 are formed at the side surface or the upper surface of each of the abutment teeth 200 besides the opposed surface of each of the abutment teeth 200; however it is preferred that the pin holes 202 are formed opposite to the opposed surfaces facing the abutment teeth 200, respectively, for thereby reinforcing the support force of the support member 220 when supporting the denture 100. In addition, the tolerance can be more easily controlled when engaging the denture. Esthetic feeling can be enhanced since the support member 220 or the fixing member 110 is not visually observed when viewing them from the sides.

The cut-away portions 203 and 201 are formed at the engaging surface and the rim portions of the upper surfaces of each of the abutment teeth 200 coming contact with the denture 100, and the tooth-shaped mold is made using a dental impression material, so the support member 220, the denture 100 and the fixing member 110 are molded.

The thusly made support member 220 is covered on the cut-away portion 203 and the ct-away portion 201 of the engaging surfaces of each of the abutment teeth 200 and at the same time the pin 222 is fixedly inserted in the pin hole 202 of each of the abutment teeth 200, and the engaging groove 111 of the denture 100 fits the support portion 220a of the support member 220 engaged to each of the abutment teeth 200, so the denture 100 is fixed between the abutment teeth 200.

At this time, a small amount of adhesive or filler is filled in the cut-away portion 203 of the engaging surface of the abutment teeth 200 coming into contact with the support 221 of the support member 220 and the inner surface of the support member, the cut-away portion 201 of the rim portion of the upper surface, so the support member 220 can be attached to the abutment teeth 200, respectively, in a sealing way. FIG. 5 is a view illustrating an operation of the dental prosthetic appliance according to the present invention.

As described above, the dental prosthetic appliance according to the present invention has features in that the damages which used to happen in the conventional art due to the cutting-away of the abutment teeth can be prevented. It is possible to reduce operation time which was longer in the conventional implant prosthetic operation, and the cost can be reduced, and a patient's psychological repulsion can be prevented, so the present invention provides a human friendly prosthetic appliance.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A dental prosthetic appliance which is configured to fix at a portion of a damaged tooth a denture (100) with the aid of a fixing member (110) and a support member (220) which correspond to a denture fixing means (300), comprising:
a configuration consisting of a cut-away portion (203) formed with a depth of 1-2 mm at one side surface of an abutment tooth (200) contacting with a denture (100), a cut-away portion (201) formed with a depth of 1-2 mm at a rim portion of an upper surface of the abutment tooth (200) and extending from the cut-away portion (203), and a pin hole (202) which is obliquely formed at a portion where the cut-away portions (201 and 203) meet;
a configuration in which the denture (100) has an engaging surface contacting with each of an abutment tooth (200) and a fixing member (110) with an engaging groove (111) for the same not to expose to the sides of a tongue or lips, and the fixing member (110) has a concave shaped engaging part (110a) with a curvature corresponding to each of the abutment teeth at the engaging surface at the side of the denture (100) contacting with each of the abutment teeth (200); and
a configuration in which the support member (220) engaging the denture (100) and the abutment teeth (200) has a trapezoid shaped support portion (220a) which is shaped in a T-shape inserted in the engaging groove (111) formed at the fixing member (110) of the denture and it is shaped with its upper side being wider and its lower side being narrower, and a support (221) extends in three directions from the support portion (220a) for the purpose of being closer to the cut-away portions (201 and 203) of the abutment teeth and covering the same, and a fixing pin (222) is obliquely inserted in the pin hole (202) of each of the abutment teeth for the purpose of enhancing the engaging force between the support member (220) and the abutment teeth (200).
